(19) United States
(12) Patent Application Publication
(10) Pub. No.: US 2006/0175778 A1
(43) Pub. Date: Aug. 10, 2006

(54) Retractable shopping cart cover apparatus and method

(76) Inventors: Amanda Cory Rose, Villa Rica, GA (US); Stephen Thompson Rose, Villa Rica, GA (US)

Correspondence Address: N. Andrew Crain;THOMAS, KAYDEN, HORSTEMEYER, & RISLEY, L.L.P., 100 Galleria Parkway, N.W., Suite 1750, Atlanta, GA, 30339-5948, US

(21) Appl. No.: 11/055,157

(22) Filed: Feb. 10, 2005

(51) Int. Cl. B62D 39/00

(52) U.S. Cl. 280/33.992

(57) ABSTRACT

A retractable cover apparatus and method to protect items in a shopping cart from inclement weather includes a cover material that is configured to cover a predetermined surface area of the shopping cart. The cover material is extendable from a housing module, which is configured to couple to a portion of the shopping cart, such as one end. The housing module has one or more coupling members that are configured to secure the housing module to the shopping cart. The housing module includes a tensioning device that may retract the cover material when a fastener coupled to the cover material is not coupled to the shopping cart.

### TECHNICAL FIELD

This disclosure relates to a retractable cover, and, more specifically, to an apparatus and method to protect items in a shopping cart from inclement weather.

### BACKGROUND

Inclement weather is a great inconvenience to a shopper. Rain, snow, and/or sleet saturate purchased goods contained in a shopping cart.

FIG. 1 is a diagram of shopping cart 10 shown placed in an environment where when rain 12 is falling upon the shopping cart such as when a consumer attempts to transport the goods 19 from the inside of the retail store to the consumer's vehicle outside of the store. Oftentimes during inclement weather, such as rain, snow and/or sleet, the purchased items in the shopping cart 10 are exposed to the environment such that the rain 12 may fall directly on the items. When the distance that the consumer travels from the retail store to the consumer's vehicle is substantial, it is oftentimes the result that the goods 19 in the shopping cart 10 become wet and even saturated by the falling rain 12. Some such goods 19, even if bagged, may be destroyed if contacted by a sufficient amount of rain 12.

As an additional nonlimiting example, mothers transporting children in addition to the goods 19 in the shopping cart typically will attend to the safety and security of their children prior to unloading the goods from the shopping cart. While the mother is attending to the safety of her children, the goods 19 in the shopping cart are exposed to rain 12 for an extended time, which increases the likelihood that some goods 19 may be saturated and/or ruined.

Therefore, a heretofore unaddressed need exists to address the aforementioned deficiencies and shortcomings described above.

### BRIEF DESCRIPTION OF THE DRAWINGS

Many aspects of the invention can be better understood with reference to the following drawings. The components in the drawings are not necessarily to scale, emphasis instead being placed upon clearly illustrating the principals of the present invention.

FIG. 1 is a diagram of a shopping cart loaded with items, such as groceries and similar goods.

FIG. 2 is a diagram of the shopping cart of FIG. 1 equipped with retractable cover 15.

FIG. 3 is a top view diagram of the shopping cart of FIG. 2 showing the retractable cover extended and latched to a portion of the shopping cart via a hook.

FIG. 4 is a perspective view of a portion of the shopping cart of FIG. 1 that depicts the placement of the retractable cover within the interior of the top of the shopping cart.

FIG. 5 depicts side and bottom views of the base section.

FIG. 6 is a top view diagram of a portion of the shopping cart preconfigured for the receipt of the retractable cover.

### DETAILED DESCRIPTION

In addition to the drawings discussed above, this description describes one or more embodiments as illustrated in the above-referenced drawings. However, there is no intent to limit this disclosure to a single embodiment or embodiments that are disclosed herein. On the contrary, the intent is to cover all alternatives, modifications, and equivalents included within the spirit and scope of this disclosure and as defined by the appended claims.

A retractable cover apparatus and method to protect items in a shopping cart from inclement weather includes a cover material that is configured to cover a predetermined surface area of the shopping cart. The cover material is extendable from a housing module, which is configured to couple to a portion of the shopping cart, such as one end. The housing module has one or more coupling members that are configured to secure the housing module to the shopping cart. The housing module includes a tensioning device that may retract the cover material when a fastener coupled to the cover material is not coupled to the shopping cart.

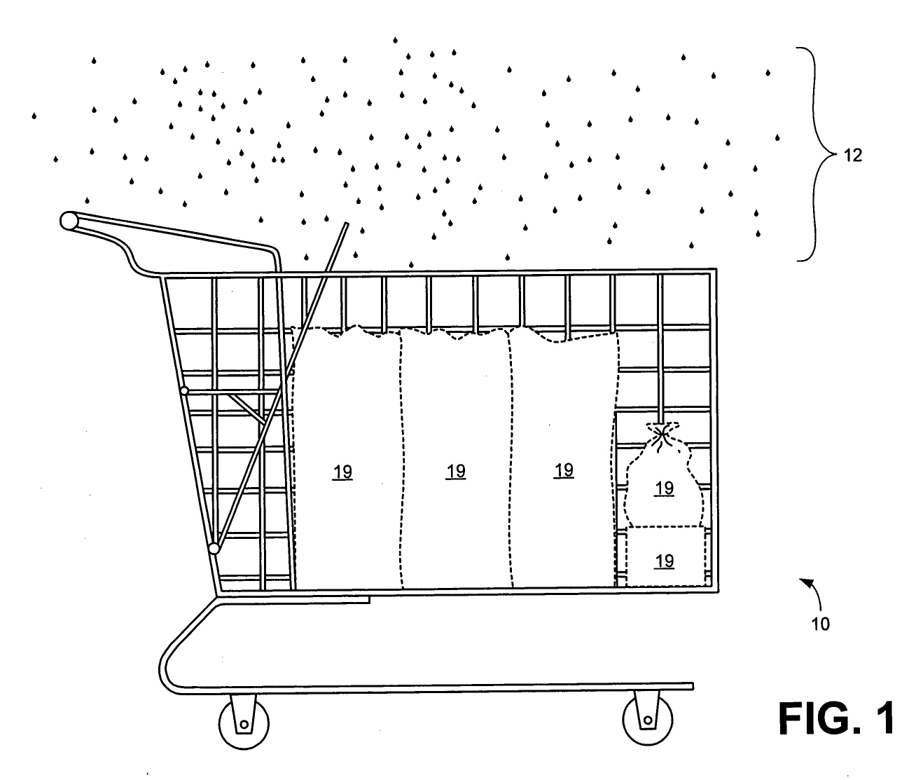

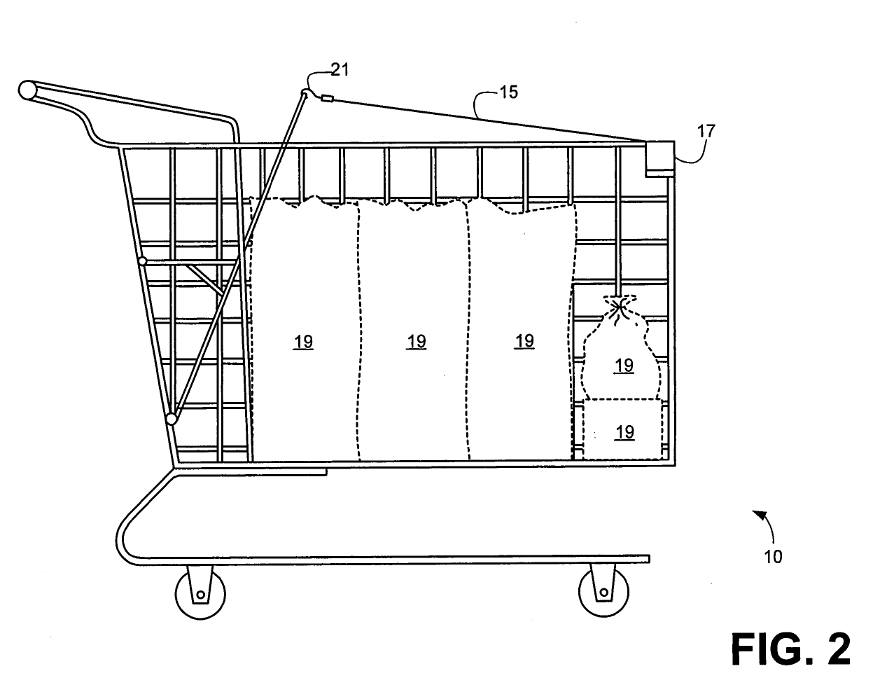

FIG. 2 is a diagram of shopping cart 10 of FIG. 1, but otherwise equipped with retractable cover 15. As shown in a nonlimiting example of FIG. 1, retractable cover 15 extends from base section 17 that is placed at the forward end of shopping cart 10. In this nonlimiting example, base section 17 is preconfigured in the shopping cart structure so as to fit to shopping cart 10.

The base section 17 includes the retractable cover 15 that may be unrolled and extended over the length of the top portion of the shopping cart 10 so as to shield the retail goods 19 from rain 12, which is shown in FIG. 1. Retractable cover 15 may be configured, in one nonlimiting example, with a hook 21 or other latching mechanism on its end so as to latch with another portion of the shopping cart 10, which operates to maintain a position of retractable cover 15 that shields goods 19 from rain 12 or other inclement weather. One of ordinary skill in the art would know that retractable cover 15 may be constructed of any such flexible material that may be extended or retracted while providing sufficient protective attributes from the rain 12 or other inclement weather.

Retractable cover 15 may also be configured to display images and/or text, such as advertisements, when extended. When retractable cover 15 is extended, the store name and/or an advertisement may become visible to the purchaser operating the shopping cart 10. One of ordinary skill would know of multiple methods for placing text and/or images on a surface of the retractable cover 15.

In one nonlimiting example, the purchaser of retail goods 19, by preparing to depart from the retail store and travel to inclement weather, may extend retractable cover 15 from base section 17 so as to cover goods 19 from the rain while traveling to the purchaser's vehicle. The purchaser merely hooks the retractable cover 15 via hook 21 onto another portion of the shopping cart 10 at a sufficient position to cover goods 19. One of ordinary skill in the art would know, however, that hook 21 may be any type of latching mechanism sufficient to hold retractable cover 15 in a desired position. Upon reaching the purchaser's vehicle, the user may unlatch or unhook hook 21 from the shopping cart 10 to allow retractable cover 15 to extend back to base section 17. In one nonlimiting example, retractable cover 15 may be spring loaded within base section 17 so that upon the release of hook 21, the spring automatically provides tension on retractable cover 15 that results in the rolling action of retractable cover 15 within base section 17. Other types of devices, as one of skill in the art would know, can also be used to place tension on retractable cover 15, which causes the winding action of retractable cover 15, as described above.

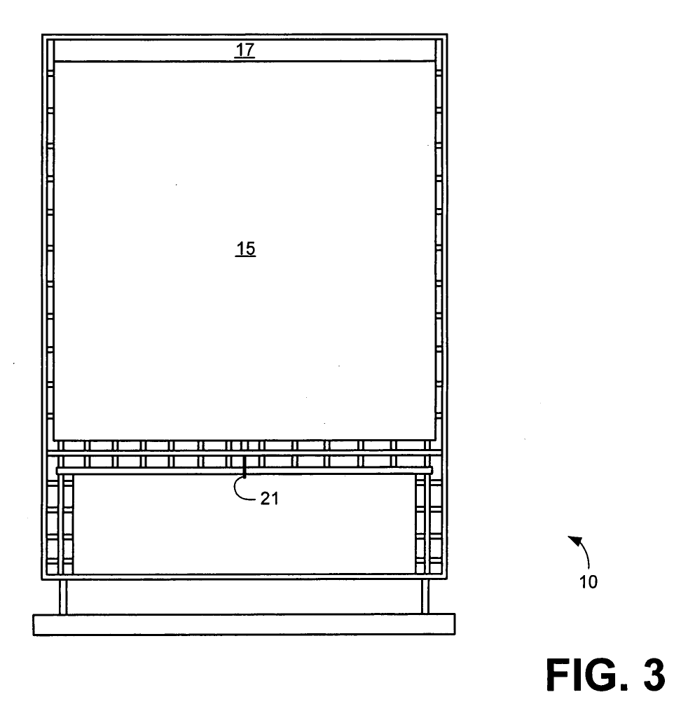

FIG. 3 is a top view diagram of the shopping cart 10 showing retractable cover 15 extended and latched to a portion of shopping cart 10 via hook 21. Base section 17 is shown on the end of shopping cart 10 and is within the outer dimensions of shopping cart 10, which obviates any potential changes to an otherwise customary shopping cart. Nevertheless, as shown in FIG. 3, the extension of retractable cover 15 to its fully extended position provides a significant cover over the goods 19 that may be placed within shopping cart 10.

In this nonlimiting example, retractable cover 14 has a uniform width. But one of ordinary skill in the art would know that retractable cover 15 may have a non-uniform width. The retractable cover 15 may be tapered so that it covers the shopping cart opening, which may not be square.

One of ordinary skill in the art would also know that one or more additional hooks 21 may be coupled to retractable cover 15, which provides additional stability depending upon various shopping cart designs. Stated another way, this disclosure is not intended to be limited to any single design shown or depicted in the several figures.

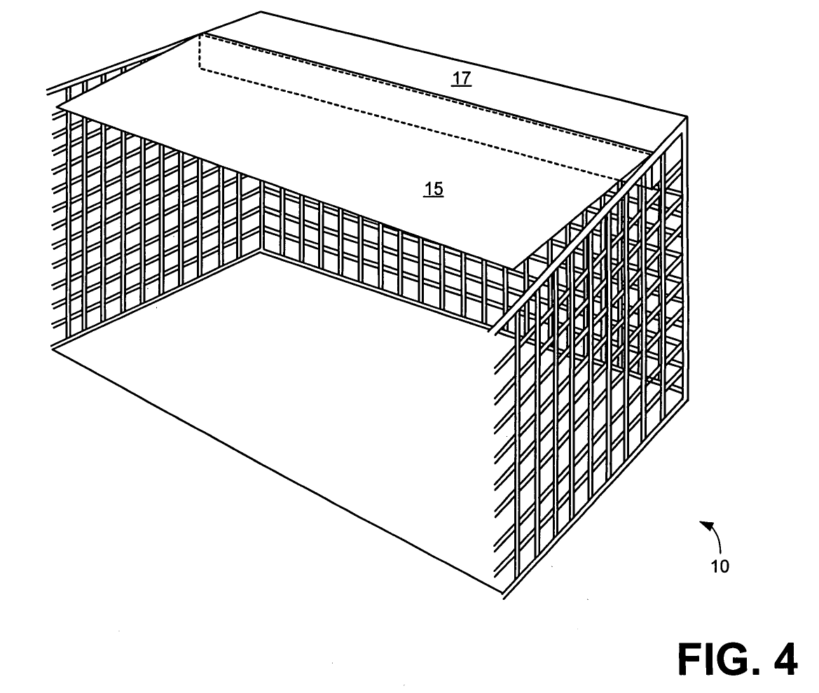

FIG. 4 depicts the placement of base section 17 within the interior of the top of the shopping cart opening. As shown in FIG. 4, base section 17 may be configured in a shopping cart to be positioned at the top front section of the opening, which provides minimal detraction from the capacity of shopping cart 10. Yet, by placing base section 17 in this position, the retail store is still able to collect multiple shopping carts in a fashion known to one of ordinary skill in the art, which could otherwise be reduced if base section 17 were positioned on the outside of the shopping cart 10.

Additionally, base section 17 may be configured or may be sized to house a sufficient length of retractable cover 15, which may be sized not only to cover items that may be below the opening of shopping cart 10, but also situations where goods 19 actually exceed above the sides of shopping cart 10, thereby causing retractable cover 15 to be extended.

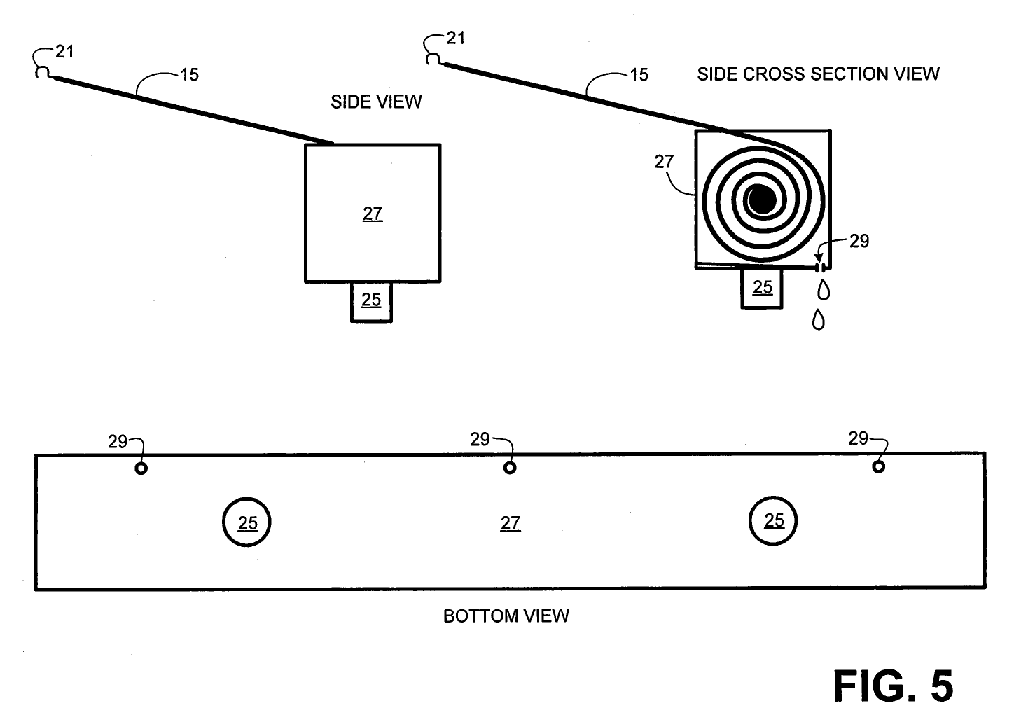

Base section 17 may be constructed of any suitable material, as one of ordinary skill in the art would know. In one nonlimiting example, base section 17 is constructed of a plastic material. Moreover, many shopping carts are also constructed of plastic materials, which enables such shopping carts to be premolded for receipt of base section 17, as shown in FIG. 5.

FIG. 5 is a diagram showing side, bottom and cross-section views of base section 17. In the nonlimiting examples of FIG. 5, the side view of base section 17 is shown with a mounting post 25. Mounting post 25 may be preconfigured in base section 17 to snap into or couple within shopping cart 10.

It is envisioned that as retractable cover 15 and base section 17 age, these items may become unserviceable or unusable and merit replacement. Thus, by making base section 17 modular to shopping cart 10, the retail store owner may remove one base section 17 and retractable cover 15 as an integrated unit and replace it with a new base section 17 with a new retractable cover 15 in simple fashion. The bottom view of base section 17 depicts surface 27 which, in this nonlimiting example, shows two mounting posts 25 and three weep holes 29. Weep holes 29 are positioned in this nonlimiting example across the length of the bottom of surface 27. These weep holes 29 channel water that may have fallen on retractable cover 17 and collected within the interior portion of base section 17 upon the rolling up of retractable cover 15. If allowed to remain in side base section 17, water may cause mold or mildew on the retractable cover 15 depending on its construction or otherwise shorten the lifespan or useful life of retractable cover 15 and base section 17. Accordingly, weep holes 29 allow water to be channeled from the inside of base section 17, thereby prolonging the useful life of retractable cover 15.

The side cross-section view, as shown in FIG. 5, depicts the retracting of retractable cover 15 within the interior portion of base section 17. One of ordinary skill in the art would know that a wiping action may occur at the entry point of retractable cover 15 to base section 17 or at another point within the interior of base section 17 to remove water from base section 17. As shown in the side cross-section view in FIG. 5, the bottom portion of base section 17 may be slanted to channel water in the direction toward weep holes 29, as shown in the side cross-section view. Thus, on rainy days when retractable cover 15 is extended and covered with water, the retraction of retractable cover 15 within base section 17 causes the water to be removed and expelled from the interior portion of base 17, which prolongs the useful life of the retractable cover 15.

One of ordinary skill in the art would know, however, that the base section 17 may be configured in various formats and constructs to improve or adjust the installation and removal of base section 17 as well as the removal of water from the interior compartment of base section 17. As stated above, one or more wipers or other water removing devices may be inserted within the interior portion of base section 17 to channel water or snow or other undesirable elements. Moreover, mounting post 25 may be configured with securing means such as snaps, latches or other tension or friction mechanisms though as to more securely attach base section 17 to shopping cart 10.

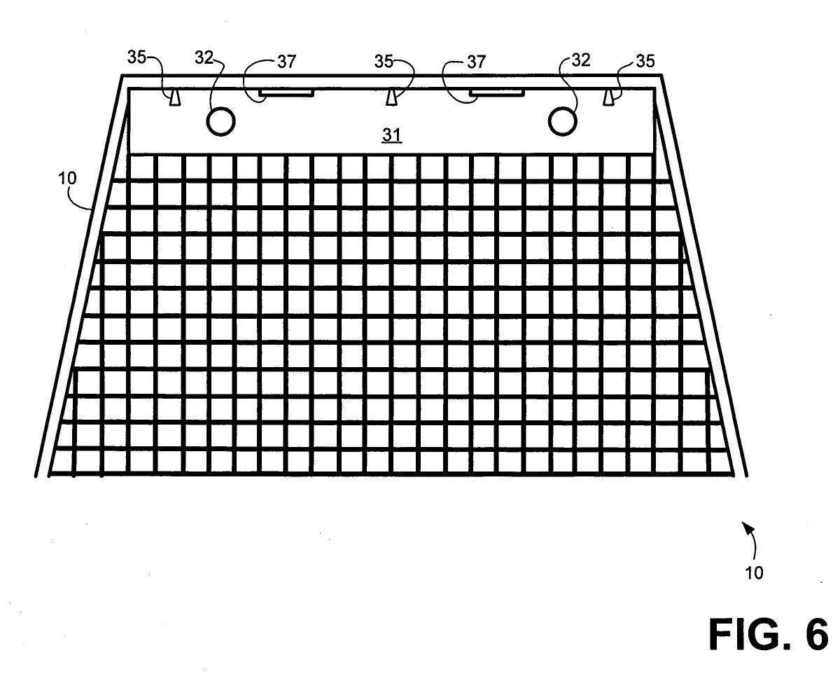

FIG. 6 is a top view diagram of shopping cart 10 preconfigured for the receipt of base section 17. In this nonlimiting example, shopping cart 10 is premolded or premanufactured for the receipt of base section 17. In this nonlimiting example, shopping cart 10 is equipped such that a flat base 31 receives the bottom portion 27 of base section 17. Continuing with this nonlimiting example, mounting post 25 of base section 17 may be configured to fit within receptacle 32 to provide stability when the retractable cover 15 is extended and retracted. As stated above, mounting post 25 may be configured with an attaching mechanism, such as a snap, flatch, or other mounting device. Therefore, receptacle 32 may be similarly configured for the receipt of such attaching mechanisms.

Shopping cart 10 in this nonlimiting example is preconfigured with water channels 35 which are aligned to be below weep holes 29 of FIG. 5. Consequently, as water is channeled from the interior portion of base section 17, water travels from base section 17 and is routed via channels 35 from the interior section of shopping cart 10. Although not shown in this nonlimiting example, channels 35 may lead to passageways to the perimeter of shopping cart 10 so that water is thoroughly and completely kept from goods 19 within the interior section of shopping cart 10.

As an additional nonlimiting example, latches 37 may be preconfigured in shopping cart 10 so as to further secure base section 17 when mounted into shopping cart 10 as shown in FIG. 6. Latches 37 may be any type of tension device that locks base section 17 in a fixed position during its useful life.

The configuration of base section 17 and shopping cart 10 is such that one may quickly and easily detach the base section 17 (with its retractable cover 15) from shopping cart 10 and install a new base section 17 (with its new retractable cover 15). This simple exchange enables the retail store owner to quickly remove a damaged, worn, inoperable, etc. base section 17 (and their respective retractable covers 15). The base section 17 and retractable cover may have a useful life span that differs from that of the shopping cart 10, thereby enabling the retail store owner interchangeability.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. A cart, comprising:
a receiver portion configured in a portion of the cart;
a housing module configured to couple to the receiver portion according to one or more securing devices that position the housing module to the cart, the housing module further comprising:
a flexible sheet material configured to extend from within the housing module and cover a portion of the cart;
a fastener coupled to the flexible sheet material and configured to maintain the flexible sheet material in a predetermined position; and
a retractor in the housing module configured to retract a portion of the flexible sheet material into the housing module when the flexible sheet material is not in a predetermined position.

2. The cart of claim 1, wherein the cart is constructed of plastic.

3. The cart of claim 1, wherein the flexible sheet material has a non uniform width.

4. The cart of claim 1, wherein the receiver portion includes one or more female members that couple to one or more male members on the housing module.

5. The cart of claim 1, wherein the receiver portion has one or more latching devices configured to secure the housing module to the cart.

6. The cart of claim 1, wherein the housing module has one or more securing devices to secure the housing module to the cart.

7. The cart of claim 1, wherein the fastener is a hook.

8. The cart of claim 1, wherein the retractor includes a spring within the housing module.

9. A product protector on a cart, comprising:
a cover material configured to cover a predetermined surface area;
a housing module coupled to the cover material and configured to couple to an end portion of the cart, the housing module having one or more securing modules that couple to a receiving portion on the cart to secure the housing module to the cart;
a tension device coupled to the housing module configured to retract the cover material into the housing module; and
one or more passages in a bottom portion of the housing module.

10. The protector of claim 9, wherein the tension device is a spring.

11. The protector of claim 9, further comprising:
a hooking device configured to hold the cover material in a predetermined and extended position.

12. The protector of claim 9, wherein the cover material is configured with one or more text messages or images on a top surface of the cover when extended from the housing module.

13. The protector of claim 9, further comprising:
a slanted surface along an interior area of its bottom portion of the housing module.

14. The protector of claim 13, wherein the slanted surface directs water to the one or more passages.

15. A method for covering items in a cart, comprising the steps of:
extracting a cover material from a housing module over a portion of the cart, the housing module detachably coupled to the cart according to one or more securing devices on the housing module and on the cart;
holding the cover material in a predetermined extended position according to one or more latching devices coupled to the cover material and configured to couple to a portion of the cart;
tensioning the cover material within the housing module so that a portion of the cover material retracts within the housing module when the latching device is decoupled from the cart; and

16. The method of claim 15, further comprising the step of:
routing water from the cover material retracted within the housing module from the interior of the housing module through one or more passages in the bottom portion of the housing module.

17. The method of claim 15, wherein the securing devices are male members configured to couple to one or more female members on the cart.

18. The method of claim 15, wherein the securing devices lock the housing module to the cart.

19. The method of claim 15, further comprising the steps of:
displaying one or more words or images on the cover material.

20. The method of claim 15,
removing the housing module from the shopping cart; and
installing a second housing module on the cart, the second housing module having a second cover material.
